(19) United States
(12) Patent Application Publication
(10) Pub. No.: US 2008/0270301 A1
(43) Pub. Date: Oct. 30, 2008

(54) MOBILE PAYMENT SYSTEM AND METHOD

(75) Inventors: Jessica U. Jones, Hurstpierpoint (GB); Lee J. Peart, Epsom (GB); Blayn W. Beenau, Peoria, AZ (US); Peter D. Saunders, Salt Lake City, UT (US); Brian T. Barnes, South Jordan, UT (US)

Correspondence Address: FITZPATRICK CELLA HARPER & SCINTO, 30 ROCKEFELLER PLAZA, NEW YORK, NY, 10112, US

(73) Assignee: AMERICAN EXPRESS TRAVEL RELATED SERVICES CO., INC., New York, NY (US)

(21) Appl. No.: 11/741,243

(22) Filed: Apr. 27, 2007

(51) Int. Cl. G06Q 40/00; G06Q 90/00

(52) U.S. Cl. 705/41

(57) ABSTRACT

A method which enables a merchant to obtain payment for a purchase from a customer who uses a mobile communication device to make the purchase, including uploading an application program to the customer's mobile communication device, and receiving a request for payment from a merchant terminal. The request for payment includes an identification code of the customer's mobile communication device and a purchase amount. The method further includes transmitting a purchase message to the customer's mobile communication device, the purchase message including an identification of the merchant, the purchase amount, and a request for purchase confirmation. The method further includes receiving a response to the request for purchase confirmation transmitted from the customer's mobile communication device, and if the response to the request for purchase confirmation is affirmative, transmitting to the merchant terminal information identifying a financial account belonging to the customer.

### RELATED APPLICATIONS

The following applications, each of which is incorporated herein by reference, were filed concurrently with the present application and include subject matter that is related to the subject matter of the present application:

U.S. application Ser. No. TBD (Attorney Docket No. 03292.012530);
U.S. application Ser. No. TBD (Attorney Docket No. 03292.102550); and
U.S. application Ser. No. TBD (Attorney Docket No. 03292.102560).

### BACKGROUND OF THE INVENTION

1. Field of the Invention

The present invention generally relates to financial payment systems, and more particularly to methods, systems, apparatuses, and computer program products for enabling a merchant to obtain payment for a purchase from a consumer who uses a mobile communication device to make the purchase.

2. Related Art

Consumers very often use financial transaction instruments as convenient forms of payment for purchases of goods and/or services (“goods/services”) instead of cash or checks. Traditionally, a “financial transaction instrument” is embodied as a card-shaped device, also referred to herein as a “card,” and may be any of the following: a traditional “plastic” transaction card (e.g., a credit card, a charge card, a debit card, a pre-paid or stored-value card, or the like); a titanium-containing, or other metal-containing, transaction card; a clear or translucent transaction card; a foldable or otherwise unconventionally-sized transaction card; or any other type of card used in connection with a financial transaction.

Typically, a consumer will make a purchase in person or online using cash or a financial transaction instrument. Often, a consumer will make a purchase over the telephone for the sake of convenience, for example, if the consumer is ordering a pizza. When a consumer makes a purchase over the telephone, the consumer may, for example, give a credit card number as a way of effecting payment, and then sign the credit card receipt upon being presented with the purchased item. Alternatively, the consumer may pay in cash or check upon being presented with the purchased item. However, these ways of effecting payment in a purchase made over the telephone can be inconvenient and can add time to the process for the consumer and for the merchant. They can also add cost to the process because there are risks to the merchant in a telephone transaction, in that payment from the consumer is not yet confirmed. There exists, therefore, a need to provide a payment system that can reduce the time involved in the process and that can alleviate the inconvenience associated therewith. There also exists a need to provide a reliable payment system for handling orders over the telephone.

### BRIEF DESCRIPTION OF THE INVENTION

The present invention meets the above-identified needs by providing methods, systems, apparatuses, and computer program products for enabling a merchant to obtain payment for a purchase from a consumer who uses a mobile communication device to make the purchase. Various embodiments of the present invention provide the advantage of making the process for paying for the purchase more convenient to the consumer and the merchant. Another advantage is that the time involved in the purchase process can be reduced. Yet another is that the risk to a merchant in a telephone transaction is reduced, because payment from the consumer is confirmed in advance, thereby reducing cost.

In accordance with one embodiment of the present invention, there is provided a computer-readable storage medium storing control logic for causing a computer to enable a merchant to obtain payment for a purchase from a customer that uses a mobile communication device to make the purchase. First computer-readable program code causes the computer to receive a request for payment transmitted from a merchant terminal, the request for payment including an identification code of the customer's mobile communication device and a purchase amount. Second computer-readable program code causes the computer to transmit a purchase message to the customer's mobile communication device, the purchase message including an identification of the merchant, the purchase amount, and a request for purchase confirmation. Third computer-readable program code causes the computer to receive a response to the request for purchase confirmation transmitted from the customer's mobile communication device. Fourth computer-readable program code causes the computer to transmit to the merchant terminal information identifying a financial account belonging to the customer upon determining that the response to the request for purchase confirmation is affirmative.

The mobile communication device may be a mobile telephone, and the identification code may be a caller identification number of the customer's mobile communication device. The request for payment may include a type of purchase.

The control logic of the computer program product may further comprise fifth computer-readable program code for causing the computer to transmit a message to the merchant terminal denying the request for payment upon determining that the response to the request for purchase confirmation is negative.

The control logic of the computer program product may further comprise fifth computer-readable program code for causing the computer to transmit a message to the merchant terminal denying the request for payment if no response to the request for purchase confirmation is received within a predetermined time interval.

The control logic of the computer program product may further comprise fifth computer-readable program code for causing the computer to transmit to the mobile communication device a payment application program. The purchase message transmitted to the customer's mobile communication device may be a text message and may cause the payment application program to execute on the customer's mobile communication device. The payment application program may cause a user interface to be displayed on the customer's mobile communication device enabling the customer to respond to the request for purchase confirmation.

In accordance with another embodiment of the present invention, there is provided a computer system that includes a processor and a memory storing control logic for causing the processor to enable a merchant to obtain payment for a purchase from a customer that uses a mobile communication device to make the purchase. First computer-readable program code causes the processor to receive a request for payment transmitted from a merchant terminal, wherein the request for payment includes an identification code of the customer's mobile communication device and a purchase amount. Second computer-readable program code causes the processor to transmit a purchase message to the customer's mobile communication device, wherein the purchase message includes: an identification of the merchant, the purchase amount, and a request for purchase confirmation. Third computer-readable program code causes the processor to receive a response to the request for purchase confirmation transmitted from the customer's mobile communication device. Fourth computer-readable program code causes the processor to transmit to the merchant terminal information identifying a financial account belonging to the customer upon determining that the response to the request for purchase confirmation is affirmative.

In accordance with another embodiment of the present invention, there is provided a method for enabling a merchant to obtain payment for a purchase from a customer that uses a mobile communication device to make the purchase. The method includes receiving a request for payment from a merchant terminal. The request for payment includes an identification code of the customer's mobile communication device and a purchase amount. The method further includes transmitting a purchase message to the customer's mobile communication device, wherein the purchase message includes: an identification of the merchant, the purchase amount, and a request for purchase confirmation. The method further includes receiving a response to the request for purchase confirmation transmitted from the customer's mobile communication device. If the response to the request for purchase confirmation is affirmative, information identifying a financial account belonging to the customer is transmitted to the merchant terminal.

The method may further include uploading an application program to the customer's mobile communication device.

In accordance with another embodiment of the present invention, there is provided a system for enabling a merchant to obtain payment for a purchase from a customer that uses a mobile communication device to make the purchase. The system includes means for receiving a request for payment from a merchant terminal. The request for payment includes an identification code of the customer's mobile communication device and a purchase amount. The system further includes means for transmitting a purchase message to the customer's mobile communication device, wherein the purchase message includes: an identification of the merchant, the purchase amount, and a request for purchase confirmation. The system further includes means for receiving a response to the request for purchase confirmation transmitted from the customer's mobile communication device, and means for transmitting to the merchant terminal information identifying a financial account belonging to the customer upon determining that the response to the request for purchase confirmation is affirmative.

The system may further include means for uploading an application program to the customer's mobile communication device.

In accordance with another embodiment of the present invention, there is provided a method for enabling a merchant to obtain payment for a purchase from a customer that uses a mobile communication device to make the purchase. The method includes receiving a request for payment from a merchant terminal. The request for payment includes an identification code of the customer's mobile communication device and a purchase amount. The method further includes transmitting a purchase message to the customer's mobile communication device, wherein the purchase message includes: an identification of the merchant, the purchase amount, and a request for purchase confirmation. The method further includes receiving a response to the request for purchase confirmation transmitted from the customer's mobile communication device. The method further includes causing the purchase amount to be transferred from a financial account of the customer to a financial account of the merchant, and transmitting to the merchant terminal a payment acknowledgment, upon determining that the response to the request for purchase confirmation is affirmative.

The method further includes uploading an application program to the customer's mobile communication device.

In accordance with another embodiment of the present invention, there is provided a system for enabling a merchant to obtain payment for a purchase from a customer that uses a mobile communication device to make the purchase. The system includes means for receiving a request for payment from a merchant terminal. The request for payment includes an identification code of the customer's mobile communication device and a purchase amount. The system further includes means for transmitting a purchase message to the customer's mobile communication device, wherein the purchase message includes: an identification of the merchant, the purchase amount, and a request for purchase confirmation. The system further includes means for receiving a response to the request for purchase confirmation transmitted from the customer's mobile communication device. The system further includes means for causing the purchase amount to be transferred from a financial account of the customer to a financial account of the merchant, and transmitting to the merchant terminal a payment acknowledgment, upon determining that the response to the request for purchase confirmation is affirmative.

The system further includes means for uploading an application program to the customer's mobile communication device.

In accordance with another embodiment of the present invention, there is provided a mobile communication device including a processor and a memory storing control logic for causing the processor to communicate with a server of a financial transaction account issuer to enable a customer to approve use of a financial transaction account of the customer for payment in a transaction with a merchant. First computer-readable program causes the processor to receive from the server a purchase message including an identification of the merchant, the purchase amount, and a request for purchase confirmation. Second computer-readable program code causes the processor to transmit to the server a response to the request for purchase confirmation.

In accordance with another embodiment of the present invention, there is provided a landline telephone device including a processor and a memory storing control logic for causing the processor to communicate with a server of a financial transaction account issuer to enable a customer to approve use of a financial transaction account of the customer for payment in a transaction with a merchant. First computer-readable program code causes the processor to receive from the server a purchase message including an identification of the merchant, the purchase amount, and a request for purchase confirmation. Second computer-readable program code causes the processor to transmit to the server a response to the request for purchase confirmation.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings, in which like reference numbers indicate identical or functionally similar elements.

FIG. 1 illustrates a mobile payment system according to an embodiment of the present invention.

FIG. 2 illustrates a flowchart illustrating a mobile payment process for a card issuer according to an embodiment of the present invention.

FIG. 3 illustrates an example of a computer system according to an embodiment of the present invention.

FIG. 4 illustrates a diagram showing a registration flow according to an embodiment of the present invention.

### DETAILED DESCRIPTION

### I. Overview

The present invention is directed to methods, systems, apparatuses, and computer program products for enabling a merchant to obtain payment for a purchase from a consumer who uses a mobile communication device to make the purchase. The present invention can provide a convenient and reliable payment system and method for paying for orders placed over the telephone.

In an embodiment of the present invention, a payment application file is downloaded to a mobile communication device, thereby enabling a consumer or owner of the mobile communication device to complete a financial transaction over the phone. When the consumer calls using the mobile communication device to order a product from a participating merchant in a financial network, the merchant's terminal is connected to the phone line and records the caller ID of the mobile communication device. The caller ID typically includes the phone number of the mobile communication device. The merchant's terminal, or POS (point of sale) terminal, uses the phone number to make a request to a gateway. In turn, a message (for example a text message) is pushed out from the gateway to the mobile communication device of the consumer who originally placed the phone call, to ask for confirmation of the transaction and amount. The consumer can reply using an interface invoked on the mobile communication device by the payment application file, and a reply message is pushed out to the gateway. The reply message can be a text message and can include the customer's funding account number as part of the payment application functionality. This funding account number can then be passed back to the merchant's terminal to process in a business-as-usual way.

### II. System

The present invention is now described in terms of an exemplary system in which the present invention, in an embodiment, would be implemented. This is for convenience only and is not intended to limit the scope of the application of the present invention. It will be apparent to one skilled in the relevant art(s) how to implement the present invention in alternative embodiments.

In an embodiment, the present invention is for use with transaction accounts of financial transaction instruments including traditional plastic transaction cards (e.g., a credit card, a charge card, a debit card, a pre-paid or stored-value card, or the like), titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid, gift, or stored value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

Of course, the present invention can be used with a financial account of any type (e.g. a loan account, a savings account, a checking account, or any other banking account) even if not associated with a financial transaction instrument.

With regard to use of a transaction account, users may communicate with card issuers or merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a server computer, although other implementations are possible.

The term “merchant” may be used herein to refer to an individual, business, entity, hardware and/or software that receives a card number to facilitate a transaction, whether or not in exchange for goods or services. For example, a merchant may be an online bookstore, or a local restaurant.

It is noted that the terms “customer,” “consumer,” or “user” are used interchangeably herein to refer to an individual, business entity, etc., that may purchase goods or services from a merchant.

In general, a transaction account may be used for transactions between a user and a merchant through any suitable communication device, such as, for example, a telephone network, an intranet, the global public Internet, a point of interaction device (e.g., a point of sale (POS) device, personal digital assistant (PDA), mobile telephone, kiosk, etc.), in online communications, off-line communications, wireless communications, and/or the like.

An “account,” “account number,” or “account code”, as used herein, may include any device, code, number, letter, symbol, digital certificate, smart chip, digital signal, analog signal, biometric, or other identifier/indicia suitably configured to allow a consumer to access, interact with, or communicate with a financial transaction system. The account number may optionally be located on or associated with any financial transaction instrument (e.g., a charge, credit, debit, prepaid, telephone, smart, magnetic stripe, bar code, transponder, or radio frequency card). The account number may be distributed and stored in any form of plastic, electronic, magnetic, radio frequency (RF), wireless, audio and/or optical device capable of transmitting or downloading data from itself to a second device.

It is noted that the terms “financial account,” “financial transaction account,” transaction account,” and “funding account” are used interchangeably herein.

A “mobile communication device” includes, but is not limited to, any of cellular telephones, beepers, pagers, iPods®, personal digital assistants (PDAs), and Blackberry® type devices.

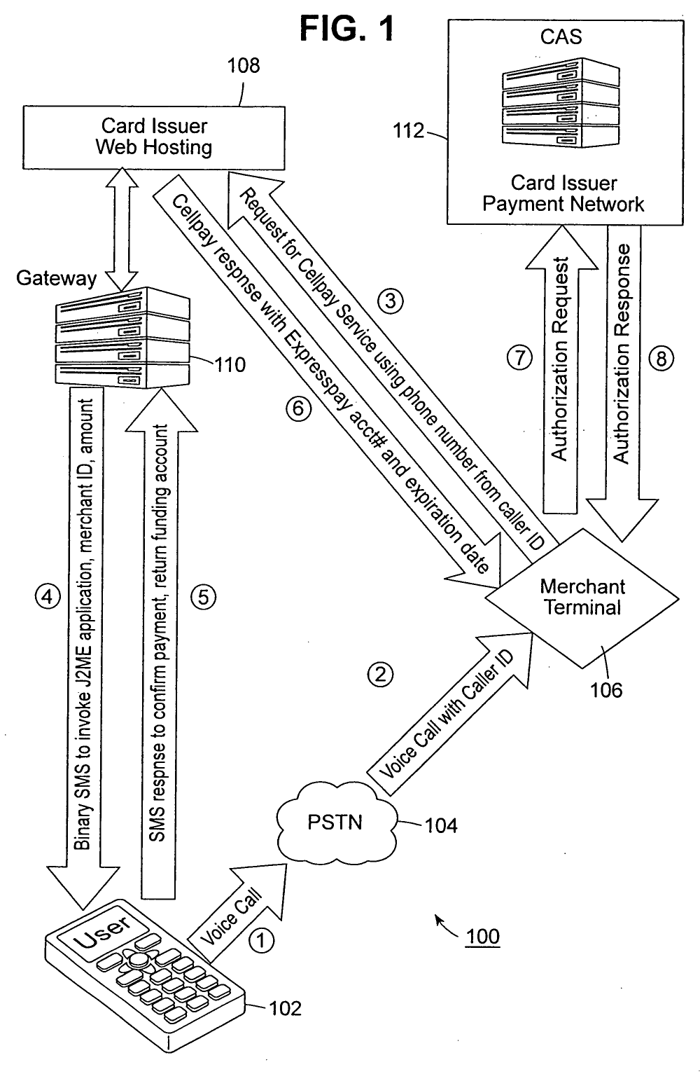

FIG. 1 illustrates a mobile payment system 100 according to an embodiment of the present invention. The mobile payment system 100 enables a merchant to obtain payment for a purchase from a consumer who uses a mobile communication device to make the purchase.

The consumer places a voice call to the merchant, for example using a mobile communication device 102. The call goes through a telephone network (e.g., a Public Switched Telephone Network) 104 and is received by a merchant or POS terminal 106. The merchant terminal 106 records the caller ID of the mobile communication device 102.

The merchant terminal 106 uses the phone number obtained from the caller ID to make a request for payment to a server 108. In one embodiment, the server 108 is an over the air gateway for passing messages from the merchant to the consumer. The server 108 may be hosted by a card issuer or network provider. The request for payment may include an identification code of the consumer's mobile communication device 102 (which can be the caller ID), a purchase amount, a type of purchase, and any other relevant information.

The server 108 transmits through gateway 110, a through-way which may be operated by (for example) a mobile communication device provider, a purchase message to the mobile communication device 102 from which the phone call was originally placed, to request confirmation of the transaction and the amount. The purchase message may be, for example, a text or SMS (Short Message Service) message, and may include an identification of the merchant, the purchase amount, the purchase type, a request for purchase confirmation, and any other relevant information.

Upon receipt of the purchase message, a payment application program, for example a J2ME (Java 2 Platform) program, is executed on the mobile communication device 102. The payment application program causes a user interface to be displayed on the mobile communication device 102, enabling the consumer or an authorized user, as explained below, to respond to the request for purchase confirmation.

The user can view information such as the identification of the merchant, the purchase type and amount, and the request for purchase confirmation, via the interface. The user can then respond, for example by replying “Yes” or “No”, to the request for purchase confirmation. The user can also be prompted to enter a PIN (“personal identification number”) to confirm that an authorized user or card member is present. In this way, the user's response confirms the purchase and approves the payment. The user's response is packaged in a message, for example in a reply text message, and is then transmitted to the server 108 through the gateway 110. The reply text message can also include the card member's funding account number as part of the payment application functionality. As used herein, the term “card member” refers to an owner of a card or a financial account.

It is noted that if, upon receipt of the purchase message from the gateway 110, the payment application program is not already present on the mobile communication device 102, the payment application program can be downloaded from the server 108 upon permission from the user. In this way, the server 108 can transmit the payment application program to the mobile communication device 102 along with the purchase message in the event that such application program is not already present on the mobile communication device 102. The application program can be downloaded in a relatively short time period, for example approximately 60 seconds.

Upon receipt of a reply message from the mobile communication device 102 confirming that the response to the request for purchase confirmation is affirmative, the server 108 transmits to the merchant terminal 106, information identifying a financial account belonging to the user, including an account number and an expiration date as well as a card issuer corresponding to the financial account. The merchant terminal 106 then transmits an authorization request to the card issuer's payment network 112 (the network 112 including a CAS or authorization system) which then returns an authorization response providing payment.

Upon receipt of a negative reply message from the mobile communication device 102, i.e., a message that denies the request for purchase confirmation, the server 108 transmits a message to the merchant terminal 106 denying the request for payment.

If no reply text message is received from the mobile communication device 102 within a predetermined time interval, the server 108 transmits a message to the merchant terminal 106 denying the request for payment.

The payment application program and a process for downloading/uploading the program to the mobile communication device 102 is described more fully in U.S. application Ser. No. TBD (Attorney Docket No. 03292.102560), filed concurrently with the present application, which has been incorporated by reference herein. Briefly, according to an embodiment, a payment application file is downloaded from the server 108 to the mobile communication device 102. As explained above, the download process can be initiated by, for example, an SMS text message sent to the mobile communication device 102. The text message contains a URL pointing to a unique jad file, which in turn contains a URL to a java application that performs as the payment application once installed on the mobile communication device 102. The java application requests a personalized package from the server 108, containing cardmember information. The cardmember information is stored on the mobile communication device 102 to enable the device 102 to make mobile payment transactions.

Of course, the invention is not limited to the details shown in FIG. 1, and various modifications can be readily envisioned. For example, a customer can place an order not through a voice call but through a text message. Also, while the present invention is described from the point of view of a mobile communication device, the present invention can be extended to enable a landline or internet telephone number to be associated with a financial account of a consumer.

A mobile communication device, a landline telephone, or an internet telephone can have a processor and a memory storing control logic for causing the processor to communicate with a server of a financial transaction account issuer to enable a customer to approve use of a financial transaction account of the customer for payment in a transaction with a merchant. A mobile communication device, a landline telephone, or an internet telephone can have a software application program resident thereon for communicating with a server of a financial transaction account issuer to enable a customer to approve use of a financial transaction account of the customer for payment in a transaction with a merchant.

### III. Process

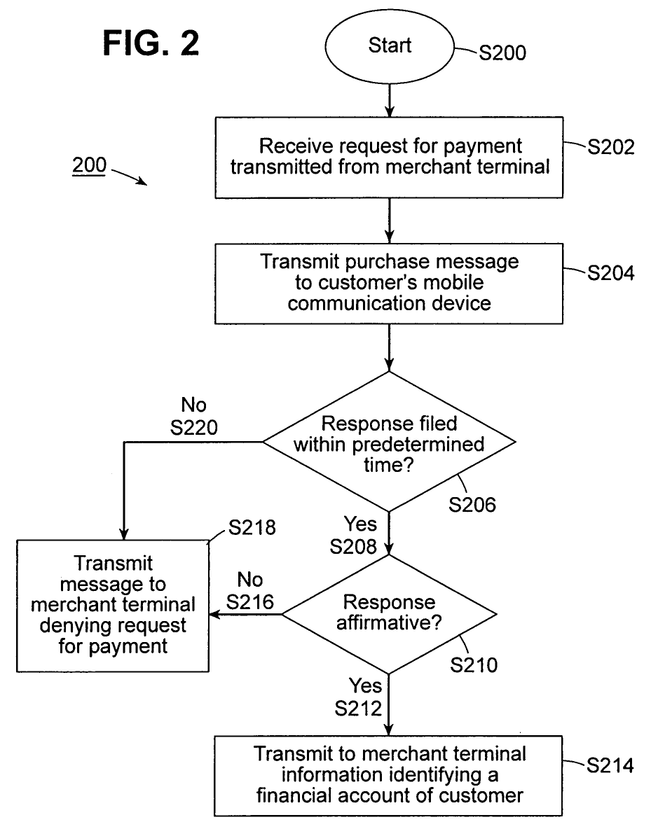

FIG. 2 shows a flowchart illustrating a mobile payment process 200 for a card issuer according to an embodiment of the present invention. The mobile payment process 200 enables a merchant to obtain payment for a purchase from a customer who uses a mobile communication device to make the purchase. Preferably, the process 200 utilizes the mobile payment system 100 shown in FIG. 1.

The process begins in Step S200. In Step S202, a request for payment transmitted from a merchant terminal 106 is received by a server 108 of the card issuer. The request for payment can include an identification code of the customer's mobile communication device 102, and a purchase amount and type. The identification code may be a caller identification number.

In Step S204, a purchase message is transmitted from the server 108 to the customer's mobile communication device 102. The purchase message can be a text message, for example, and can include an identification of the merchant, the purchase amount and type, and a request for purchase confirmation.

In Step S206, the server 108 awaits receipt of a response to the request for purchase confirmation from the customer's mobile communication device 102. The response may be, for example, a text message, and can include the customer's funding account number. If a response is received within a predetermined time period (Step S208), the server 108 determines in Step S210 whether the response is affirmative. If the response is affirmative (Step S212), then in Step S214 the server 108 transmits to the merchant terminal 106 information identifying a financial transaction account belonging to the customer, which can include an account number and expiration date. If the response is not affirmative (Step S216), then in Step S218 the sever 108 transmits to the merchant terminal 106 a message denying the request for payment.

If, in Step S206, a response to the request for purchase confirmation is not received from the customer's mobile communication device 102 within the predetermined time period (Step S220), then the flow proceeds to Step S218, in which the server 108 transmits to the merchant terminal 106 a message denying the request for payment.

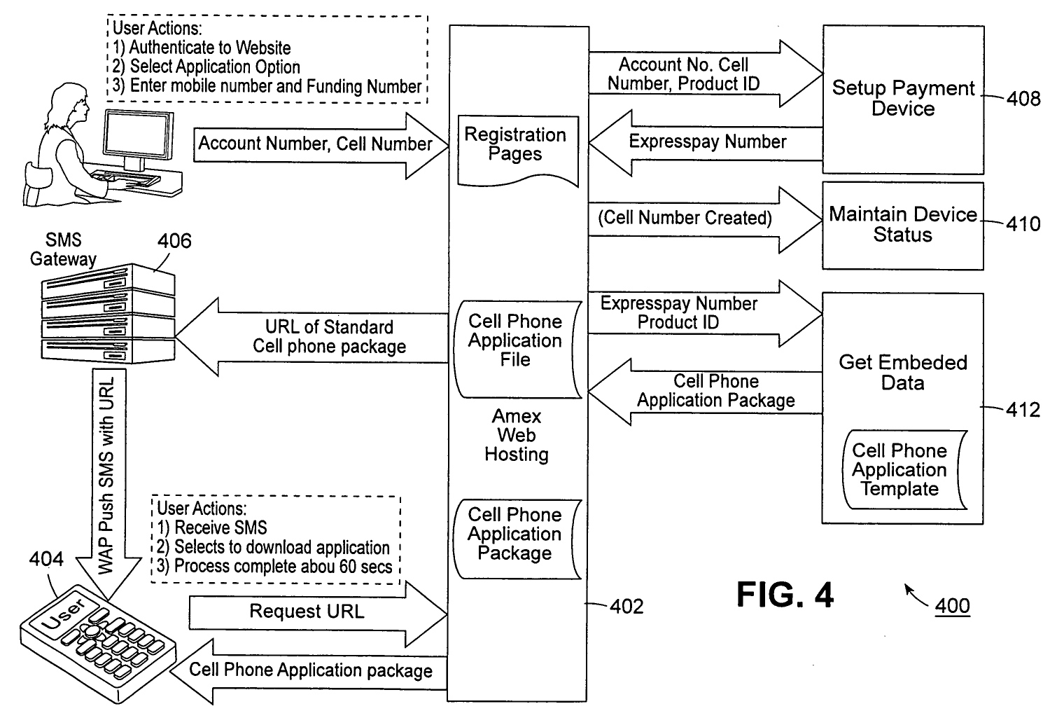

FIG. 4 illustrates a diagram showing the registration flow according to an embodiment of the invention. As shown in FIG. 4, a user accesses a website hosted by a server 402 of a card issuer, in order to register for a mobile payment system of the card issuer. In registering, the user authenticates to a website hosted by the server 402 using a password or PIN (“personal identification number”), and selects a mobile payment application option, among other options that may be available from the server 402. The user enters a mobile number of a mobile communication device 404 and a funding account number. This information is provided to the server 402.

Units 408 and 410 enable the system to check if an account already exists and to set up or replace the account details. Component 412 creates an encrypted personalized data file which may include customer account information and the customer's mobile number. In one embodiment, an alias account number or “Expresspay Number” is created, which is a secure account number that corresponds to the funding account number, in order to provide an added layer of security. An application package is created containing the personalized files and a payment application program.

Upon completion of registration, or upon receiving a purchase message from a gateway 406, the payment application program is downloaded from the server 402 by the mobile communication device 404. In order to effect this download, according to one embodiment, the server 402 sends a message to the gateway 406 containing the URL of an application package including the payment application program. A message containing the URL is pushed from the gateway 406 to the mobile communication device 404. The mobile communication device 404 selects to download the application package using the URL provided, and the application package including the payment application program is transferred to the device 404.

The payment application program enables a user interface to be displayed on the mobile communication device 404, which in turn enables the customer to perform tasks such as entering a PIN and responding to a request for purchase confirmation.

### IV. Example Implementation

The present invention or any part(s) or function(s) thereof) may be implemented using hardware, software, or a combination thereof, and may be implemented in one or more computer systems or other processing systems. Useful machines for performing some or all of the operations of the present invention include general-purpose digital computers or similar devices.

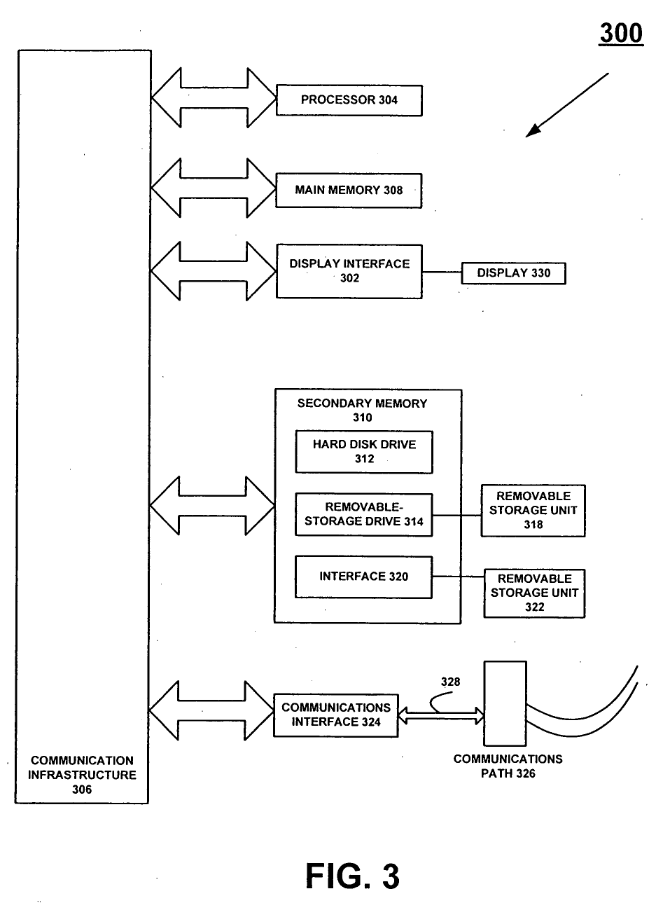

In fact, in one embodiment, the present invention is directed toward one or more computer systems equipped to carry out the functions described herein. An example of such a computer system 300 is shown in FIG. 3.

The computer system 300 includes at least one processor 304. The processor 304 is connected to a communication infrastructure 306 (e.g., a communications bus, a cross-over bar device, or a network). Although various software embodiments are described herein in terms of this exemplary computer system 300, after reading this description, it will become apparent to a person skilled in the relevant art(s) how to implement the invention using other computer systems and/or architectures.

The computer system 300 includes a display interface 302 that forwards graphics, text, and other data from the communication infrastructure 306 (or from a frame buffer (not shown)) for display on a display unit 330.

The computer system 300 also includes a main memory 308, which preferably is a random access memory (RAM), and may also include a secondary memory 310. The secondary memory 310 may include, for example, a hard disk drive 312 and/or a removable-storage drive 314 (e.g., a floppy disk drive, a magnetic tape drive, an optical disk drive, and the like). The removable-storage drive 314 reads from and/or writes to a removable storage unit 318 in a well-known manner. The removable storage unit 318 may be, for example, a floppy disk, a magnetic tape, an optical disk, and the like, which is written to and read by the removable-storage drive 314. As will be appreciated, the removable storage unit 318 includes a computer-usable storage medium having stored therein computer software and/or data.

In alternative embodiments, the secondary memory 310 may include other similar devices for allowing computer programs or other instructions to be loaded into the computer system 300. Such devices may include a removable storage unit 322 and an interface 320 (e.g., a program cartridge and a cartridge interface similar to those used with video game systems); a removable memory chip (e.g., an erasable programmable read-only memory (“EPROM”) or a programmable read-only memory (“PROM”)) and an associated memory socket; and other removable storage units 322 and interfaces 320 that allow software and data to be transferred from the removable storage unit 322 to the computer system 300.

The computer system 300 may also include a communications interface 324, which allows software and data to be transferred between the computer system 300 and external devices (not shown). Examples of the communications interface 324 may include a modem, a network interface (e.g., an Ethernet card), a communications port, a Personal Computer Memory Card International Association (“PCMCIA”) interface, and the like. Software and data transferred via the communications interface 324 are in the form of signals 328, which may be electronic, electromagnetic, optical or another type of signal that is capable of being received by the communications interface 324. These signals 328 are provided to the communications interface 324 via a communications path 326 (e.g., a channel). The communications path 326 carries the signals 328 and may be implemented using wire or cable, fiber optics, a telephone line, a cellular link, a radio-frequency (“RF”) link, or the like.

As used herein, the phrases “computer program medium” and “computer usable medium” may be used to generally refer to a removable storage unit 318 used with the removable-storage drive 314, a hard disk installed in the hard disk drive 312, or and the signals 328, for example. These computer program products provide software to the computer system 300. The present invention may be implemented or embodied as one or more of such computer program products.

Computer programs (also referred to as computer control logic) are stored in the main memory 308 and/or the secondary memory 310. The computer programs may also be received via the communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the present invention is implemented using software, the software may be stored in a computer program product and loaded into the computer system 300 using the removable-storage drive 314, the hard drive 312, or the communications interface 324. The control logic (software), when executed by the processor 304, causes the processor 304 to perform the functions of the present invention as described herein.

In another embodiment, the present invention is implemented primarily in hardware using, for example, hardware components such as application-specific integrated circuits (“ASICs”). Implementation of such a hardware arrangement so as to perform the functions described herein will be apparent to persons skilled in the relevant art(s).

In yet another embodiment, the present invention is implemented using a combination of both hardware and software.

### V. Conclusion

The various embodiments of the present invention described above have been presented by way of example and not limitation. It will be apparent to persons skilled in the relevant art(s) that various changes in form and detail can be made therein (e.g., different hardware, communications protocols, and the like) without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way.

What is claimed is:

1. A computer-readable storage medium storing control logic for causing a computer to enable a merchant to obtain payment for a purchase from a customer that uses a mobile communication device to make the purchase, the control logic comprising:
first computer-readable program code for causing the computer to receive a request for payment transmitted from a merchant terminal, wherein the request for payment includes an identification code of the customer's mobile communication device and a purchase amount;
second computer-readable program code for causing the computer to transmit a purchase message to the customer's mobile communication device, wherein the purchase message includes: an identification of the merchant, the purchase amount, and a request for purchase confirmation;
third computer-readable program code for causing the computer to receive a response to the request for purchase confirmation transmitted from the customer's mobile communication device; and
fourth computer-readable program code for causing the computer to transmit to the merchant terminal information identifying a financial account belonging to the customer upon determining that the response to the request for purchase confirmation is affirmative.

2. A computer program product according to claim 1, wherein the mobile communication device is a mobile telephone, and wherein the identification code is a caller identification number of the customer's mobile communication device.

3. A computer program product according to claim 1, wherein the control logic further comprises fifth computer-readable program code for causing the computer to transmit a message to the merchant terminal denying the request for payment upon determining that the response to the request for purchase confirmation is negative.

4. A computer program product according to claim 1, wherein the control logic further comprises fifth computer-readable program code for causing the computer to transmit a message to the merchant terminal denying the request for payment upon determining that no response to the request for purchase confirmation is received within a predetermined time interval.

5. A computer program product according to claim 1, wherein the control logic further comprises fifth computer-readable program code for causing the computer to transmit to the mobile communication device a payment application program.

6. A computer program product according to claim 5, wherein the purchase message transmitted to the customer's mobile communication device causes the payment application program to execute on the customer's mobile communication device.

7. A computer program product according to claim 6, wherein the payment application program causes a user interface to be displayed on the customer's mobile communication device enabling the customer to respond to the request for purchase confirmation.

8. A computer system including a processor and a memory storing control logic for causing the processor to enable a merchant to obtain payment for a purchase from a customer that uses a mobile communication device to make the purchase, the control logic comprising:
first computer-readable program code for causing the processor to receive a request for payment transmitted from a merchant terminal, wherein the request for payment includes an identification code of the customer's mobile communication device and a purchase amount;
second computer-readable program code for causing the processor to transmit a purchase message to the customer's mobile communication device, wherein the
purchase message includes: an identification of the merchant, the purchase amount, and a request for purchase confirmation;
third computer-readable program code for causing the processor to receive a response to the request for purchase confirmation transmitted from the customer's mobile communication device; and
fourth computer-readable program code for causing the processor to transmit to the merchant terminal information identifying a financial account belonging to the customer upon determining that the response to the request for purchase confirmation is affirmative.

9. A computer system according to claim 8, wherein the mobile communication device is a mobile telephone, and wherein the identification code is a caller identification number of the customer's mobile communication device.

10. A computer system according to claim 8, wherein the control logic further comprises fifth computer-readable program code for causing the processor to transmit a message to the merchant terminal denying the request for payment upon determining that the response to the request for purchase confirmation is negative.

11. A computer system according to claim 8, wherein the control logic further comprises fifth computer-readable program code for causing the processor to transmit a message to the merchant terminal denying the request for payment upon determining that no response to the request for purchase confirmation is received within a predetermined time interval.

12. A computer system according to claim 8, wherein the control logic further comprises fifth computer-readable program code for causing the processor to transmit to the mobile communication device a payment application program.

13. A computer system according to claim 12, wherein the purchase message transmitted to the customer's mobile communication device causes the payment application program to execute on the customer's mobile communication device.

14. A computer system according to claim 13, wherein the payment application program causes a user interface to be displayed on the customer's mobile communication device enabling the customer to respond to the request for purchase confirmation.

15. A method for enabling a merchant to obtain payment for a purchase from a customer that uses a mobile communication device to make the purchase, the method comprising:
receiving a request for payment from a merchant terminal, wherein the request for payment includes an identification code of the customer's mobile communication device and a purchase amount;
transmitting a purchase message to the customer's mobile communication device, wherein the purchase message includes: an identification of the merchant, the purchase amount, and a request for purchase confirmation;
receiving a response to the request for purchase confirmation transmitted from the customer's mobile communication device; and,
if the response to the request for purchase confirmation is affirmative, transmitting to the merchant terminal information identifying a financial account belonging to the customer.

16. A system for enabling a merchant to obtain payment for a purchase from a customer that uses a mobile communication device to make the purchase, the system comprising:
means for receiving a request for payment from a merchant terminal, wherein the request for payment includes an identification code of the customer's mobile communication device and a purchase amount;
means for transmitting a purchase message to the customer's mobile communication device, wherein the purchase message includes: an identification of the merchant, the purchase amount, and a request for purchase confirmation;
means for receiving a response to the request for purchase confirmation transmitted from the customer's mobile communication device; and
means for transmitting to the merchant terminal information identifying a financial account belonging to the customer upon determining that the response to the request for purchase confirmation is affirmative.

17. A method for enabling a merchant to obtain payment for a purchase from a customer that uses a mobile communication device to make the purchase, the method comprising:
receiving a request for payment from a merchant terminal, wherein the request for payment includes an identification code of the customer's mobile communication device and a purchase amount;
transmitting a purchase message to the customer's mobile communication device, wherein the purchase message includes: an identification of the merchant, the purchase amount, and a request for purchase confirmation;
receiving a response to the request for purchase confirmation transmitted from the customer's mobile communication device; and
causing the purchase amount to be transferred from a financial account of the customer to a financial account of the merchant, and transmitting to the merchant terminal a payment acknowledgment, upon determining that the response to the request for purchase confirmation is affirmative.

18. A system for enabling a merchant to obtain payment for a purchase from a customer that uses a mobile communication device to make the purchase, the system comprising:
means for receiving a request for payment from a merchant terminal, wherein the request for payment includes an identification code of the customer's mobile communication device and a purchase amount;
means for transmitting a purchase message to the customer's mobile communication device, wherein the purchase message includes: an identification of the merchant, the purchase amount, and a request for purchase confirmation;
means for receiving a response to the request for purchase confirmation transmitted from the customer's mobile communication device; and
means for causing the purchase amount to be transferred from a financial account of the customer to a financial account of the merchant, and transmitting to the merchant terminal a payment acknowledgment, upon determining that the response to the request for purchase confirmation is affirmative.

19. A computer program product according to claim 1, wherein the request for payment includes a type of purchase.

20. A computer program product according to claim 1, wherein the purchase message is a text message.

21. A method according to claim 15, further comprising the step of uploading an application program to the customer's mobile communication device.

22. A system according to claim 16, further comprising means for uploading an application program to the customer's mobile communication device.

23. A method according to claim 17, further comprising the step of uploading an application program to the customer's mobile communication device.

24. A system according to claim 18, further comprising means for uploading an application program to the customer's mobile communication device.

25. A mobile communication device including a processor and a memory storing control logic for causing the processor to communicate with a server of a financial transaction account issuer to enable a customer to approve use of a financial transaction account of the customer for payment in a transaction with a merchant, the control logic comprising:
first computer-readable program code for causing the processor to receive from the server a purchase message including an identification of the merchant, the purchase amount, and a request for purchase confirmation; and
second computer-readable program code for causing the processor to transmit to the server a response to the request for purchase confirmation.

26. A landline telephone device including a processor and a memory storing control logic for causing the processor to communicate with a server of a financial transaction account issuer to enable a customer to approve use of a financial transaction account of the customer for payment in a transaction with a merchant, the control logic comprising:
first computer-readable program code for causing the processor to receive from the server a purchase message including an identification of the merchant, the purchase amount, and a request for purchase confirmation; and
second computer-readable program code for causing the processor to transmit to the server a response to the request for purchase confirmation.
